(19) United States
(12) Patent Application Publication
(10) Pub. No.: US 2025/0154727 A1
(43) Pub. Date: May 15, 2025

(54) DUAL TEXTURED TISSUE PRODUCT

(71) Applicant: Kimberly-Clark Worldwide, Inc., Neenah, WI (US)

(72) Inventors: Tsutama Satake Neto, Mogi das Cruzes (BR); Jorge A. Duran, Sao Paulo (BR)

(21) Appl. No.: 18/834,642

(22) PCT Filed: Feb. 2, 2022
(86) PCT No.: PCT/US2022/014821

§ 371 Date: Jul. 31, 2024

(51) Int. Cl. D21H 27/00; B31F 1/07; B32B 7/022; B32B 7/05; B32B 29/00; B32B 29/08; D21H 27/40

(52) U.S. Cl. CPC D21H 27/005; B31F 1/07; B32B 7/022; B32B 7/05; B32B 29/005; B32B 29/08; D21H 27/40; B31F 2201/0733; B31F 2201/0738; B31F 2201/0761; B31F 2201/0787; B32B 2250/26; B32B 2307/536; B32B 2307/538; B32B 2307/54; B32B 2307/718; B32B 2307/7376; B32B 2555/00

(57) ABSTRACT

Disclosed are embossed, multi-ply tissue products having differing texture on each of their first and second outer surfaces. The difference in texture may be measured using a Tissue Softness Analyzer and the second side may have a TS750 value that is about five times greater than the TS750 value of the first side. The differing texture may be imparted by different embossing patterns disposed on the first and second surfaces where the embossments forming the second pattern are oriented such that they protrude outwardly away from the second surface. Despite having differing textures, the products are generally soft, such as having an Average TS7 value less than about 12.0 and have good sheet bulk, such as a sheet bulk greater than about 10.0 cubic centimeters per gram (cc/g).

### BACKGROUND

In the manufacture of paper products, particularly tissue products, it is generally desirable to provide an aesthetically pleasing final product with as much bulk as possible without compromising other product attributes, including softness, flexibility, absorbency, hand feel, and durability. However, most papermaking machines operating today utilize a process known as “wet-pressing.” In “wet-pressing” a large amount of water is removed from the newly formed web of paper by mechanically pressing water out of the web in a pressure nip. This wet-pressing step, while an effective dewatering means, compresses the web and causes a marked reduction in web thickness, thus reducing bulk.

To improve sheet bulk and provide the wet-pressed tissue product with an aesthetically pleasing appearance the two or more wet-pressed tissue plies are typically embossed and plied together to form the finished tissue product. One process for embossing and plying together individual plies, commonly referred to as DESL (Double Embossing Single Lamination), is illustrated in FIG. 1. In the DESL process, a first web 5 is directed through the nip N1 between an embossing roll 2 and an anvil roll 1. In this nip N1 the web 5 is provided with an embossing pattern. Thereafter, an adhesive applicator 8 applies an adhesive 9 to those parts of the first web 5 at which there are protruding embossing elements in the embossing roll 2.

A second web 6 is embossed by a second pair of rolls 3, 4 consisting of a second embossing roll 4 and a second anvil roll 3. The additional pair of rolls 3, 4 serves to emboss the second web 6. The embossing elements of the first embossing roll 2 and the embossing elements of the second embossing roll 4 are arranged such that the embossed elements of the first embossed ply 5 and the embossed elements of the second embossed ply 6 fit into each other similar to a gearing system. The embossed plies 5, 6 are brought together at a third nip N3 and then adhesively bonded together using a marrying roll 7 at a fourth nip N4.

Because the embossed elements of the first embossed ply 5 and the embossed elements of the second embossed ply 6 fit into each other similar to a gearing system, the embossed multi-ply tissue product 15 has a nested configuration, as illustrated in FIG. 2. The tissue product 15 has first and second surfaces 11, 15 having first and second outer most surface planes 13, 17. In the nested configuration the embossments 12, 10 of both the top and bottom plies 5, 6 are oriented inward towards the interior portion of the product and away from its outer surfaces 11, 15 and lie below the outer most surface planes 13, 17. The embossments are nested together to achieve a mutual stabilization of the two plies and improve product bulk.

While conventional embossing and plying processes are useful in producing tissue products having improved sheet bulks and an aesthetic appearance, the processes are lacking in their ability to produce products with differing outer surfaces. Accordingly, there remains a need in the art for imparting tissue plies, particularly wet-pressed tissue plies, with an embossing design that is aesthetically appealing, improves product bulk and provides each of the product outer surfaces with a different texture.

### SUMMARY

The present inventors have now discovered that an embossed multi-ply tissue product having a high degree of bulk and softness may be achieved by providing both the bottom and top plies of a multi-ply product with embossments. More particularly, the inventors have discovered that the bottom ply may be provided with a plurality of embossments that protrude from the bottom ply surface plane. Thus, unlike prior art tissue products having bottom ply embossments, which are oriented towards the inner, portion of the product, the instant products have embossments that protrude and are contacted by a user in use.

By providing the bottom ply with protruding embossments, the tissue products of the present invention have first and second surfaces with distinctly different surface topography and handfeel. Moreover, in certain instances, the embossed plies may be plied together in such a manner that the product not only has dual texture but also improved bulk. For example, the tissue product may have a first surface comprising a plurality of inwardly protruding embossments and have a surface smoothness, measured as a TS750 value, of about 50 or less, such as from about 10 to about 50, and a second surface comprising a plurality of outwardly protruding embossments and have a surface smoothness, measured as a TS750 value, of about 100 or more, such as from about 100 to about 150.

Hence in one embodiment, the present invention provides an embossed multi-ply tissue product comprising a first embossed tissue ply and a second embossed tissue ply arranged in facing relation and defining an interior portion there between. The embossments of the first tissue ply are oriented towards an interior portion of the product and the embossments of the second tissue ply are oriented away from the interior portion. In certain instances, the first and second embossed tissue plies are attached to one another by an adhesive disposed between the interior oriented embossments of the first ply and the second embossed tissue ply.

The inventive multi-ply tissue products generally have improved sheet bulk, such as a sheet bulk greater than about 10.0 cubic centimeters per gram (cc/g), and improved softness, such as an Average TS7 less than about 11.0 and more preferably less than about 10.0, such as from about 9.0 to about 11.0. The foregoing Average TS7 values may be obtained at a product geometric mean tensile strength (GMT) from about 700 to about 1,200 g/3″, such as from about 700 to about 1,000 g/3″. Thus, the inventive tissue products are both strong enough to withstand use and soft enough for everyday use.

In certain embodiments the caliper and sheet bulks may be increased compared to tissue products comprising plies that have been embossed such that the embossments are oriented towards the interior of the product. For example, in certain embodiments, the duel textured tissue product may comprise first and second embossed, conventional wet pressed tissue plies, and the product may have a caliper of about 275 microns or more, such as from about 275 to about 350 microns and sheet bulks from about 9.0 to about 12.0 cc/g.

In another embodiment the present invention provides a multi-ply tissue product comprising first and second embossed tissue plies arranged in facing arrangement and defining an interior portion there between. The first embossed tissue ply comprises a plurality of line embossments, which in certain embodiments are discrete, oriented towards the interior portion of the tissue product. In this manner the embossments are depressions lying below the surface plane of the first ply. The second embossed tissue ply comprises a plurality of discrete embossments, which in certain embodiments are dot embossments, oriented away from the interior portion of the tissue product. In this manner the embossments on the second ply protrude outwardly from the surface plane of the ply and may be contacted by a user in use.

In yet another embodiment, the present invention provides an embossed multi-ply tissue product comprising a first embossed tissue ply and a second embossed tissue ply arranged in facing relation and defining an interior portion there between, a plurality of first embossments disposed on the first ply and arranged in a first pattern, the plurality of first embossments oriented towards the interior portion of the product and a plurality of second embossments disposed on the second ply and arranged in a second pattern, the second embossments oriented away from the interior portion of the product, wherein the first and second patterns differ and the second ply has a TS750 value that is at least about five times greater than the TS750 value of the first ply.

In another embodiment, the present invention provides a method of manufacturing a high bulk embossed multi-ply tissue product comprising the steps of: (a) providing a first and a second tissue ply having a molded topographical pattern; (b) conveying the first tissue ply through a first embossing nip formed between a first backing roll and a first engraved embossing roll; (c) embossing a first embossed pattern onto the first ply, the first embossed pattern consisting essentially of line emboss elements; (d) conveying a second tissue ply through a second embossing nip formed between a second backing roll and a second engraved embossing roll; (e) embossing a second embossed pattern onto the second ply, the second embossed pattern consisting essentially of a plurality of dot emboss elements; and conveying the first and second tissue plies through a third nip formed between the first engraved embossing roll and a marrying roll to bring the first and second plies into facing arrangement with one another; wherein the first and second embossing patterns are arranged such that when the first and second plies are brought into facing arrangement to form a multi-ply tissue product having an interior space between the first and second plies, the dot embossments are oriented away from the interior space.

### DESCRIPTION OF THE DRAWINGS

FIG. 1 illustrates a prior art embossing process;

FIG. 2 illustrates a prior art embossed tissue product;

FIG. 3 is a cross-sectional view of an embossed tissue product according to the present invention;

FIG. 4 is a plan view of the upper surface of an embossed tissue product according to the present invention;

FIG. 5 is a plan view of the lower surface of an embossed tissue product according to the present invention

FIG. 6 is a plan view of an embossing pattern useful in forming the tissue products of the present invention; and

FIG. 7 is a schematic of an embossing process useful in producing tissue products according to the present invention.

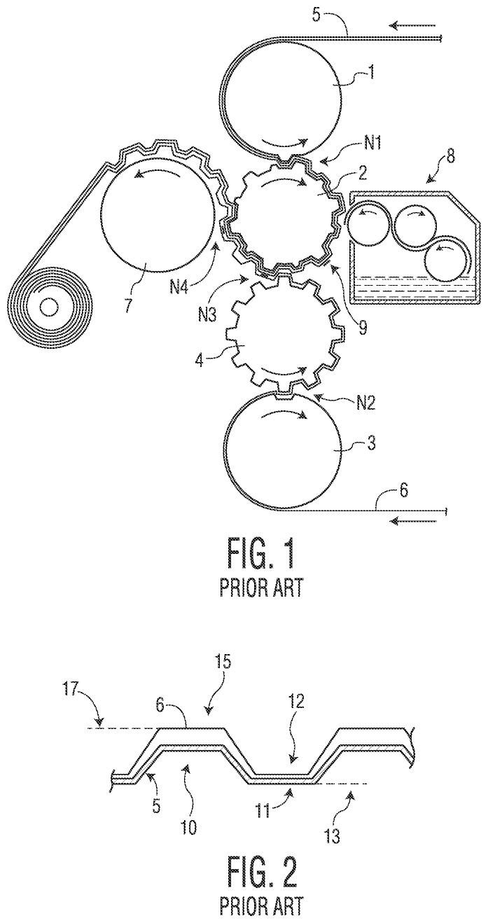

### DEFINITIONS

As used herein the term “Wet-Pressed” when referring to a tissue manufacturing process or tissue webs or products made thereby means a process whereby the nascent tissue web is partially dewatered by passing the tissue web through a nip formed by a pressure roll while supported by a press felt. Generally, the partially dewatered web has a consistency of about 40 percent or more and is subsequently adhered to the surface of a cylindrical drier to finally dry the web. Preferably the dried web is removed from the cylindrical drier by a creping blade. Suitable wet pressed tissue manufacturing processes include Valmet's New Tissue Technology (NTT), Advantage Quality Rush Transfer (“QRT”) processes and Energy Efficient Technologically Advanced Drying (ETAD), and Voith's Advanced Tissue Molding System (ATMOS) process.

As used herein the term “Basesheet” refers to tissue web formed by any one of the papermaking processes described herein but has not been subjected to further processing to convert the sheet into a finished product, such as embossing, calendering, perforating, plying, folding, or rolling into individual rolled products.

As used herein the term “Tissue Product” refers to products made from tissue webs and includes bath tissues, facial tissues, paper towels, industrial wipers, foodservice wipers, napkins, medical pads, and other similar products. Tissue products may comprise one, two, three or more plies.

As used herein the term “Ply” refers to a discrete tissue web used to form a tissue product. Individual plies may be arranged in facing relation to each other such that adjacent plies contact one another.

As used herein, the term “Surface Plane” generally refers to the plane of the predominant surface of an object, such as the surface of an engraved embossing roll or the surface of a tissue ply or product.

As used herein the term “Continuous” when referring to an element disposed on the surface of a tissue product, such as a linear element, a design element, or a pattern, means that the element extends throughout one dimension of the tissue product surface.

As used herein the term “Discrete” when referring to an element disposed on the surface of a tissue product, such as a line emboss element, a dot emboss element, a molded element, or a pattern, means that the element is visually unconnected from other elements.

As used herein, the term “Pattern” generally refers to the arrangement of a plurality of embossments on the surface of a tissue product, resulting from the tissue product being conveyed through a nip comprising an engraved embossing roll. The embossments may be discrete, semi-continuous or continuous and may comprise a line emboss element, a dot emboss element, or combinations thereof. The embossing pattern generally comprises a portion of the tissue product lying out of plane with the predominate surface plane of the tissue product.

As used herein the term “Micro-Embossments” generally refers to a plurality of discrete embossments disposed on a tissue ply where the number of embossments per square centimeter of tissue surface area (embossment density) is at least 25 embossments/cm², such as at least about 30 embossments/cm², such as at least about 40 embossments/cm², such as from 25 to about 80 embossments/cm². In certain embodiments the micro-embossments may consist of small protuberances on a given tissue ply and be formed by small protrusions on an embossing roll which press against and into the tissue ply to be embossed. The micro-embossments may be arranged in a pattern and may cover at least about 5 percent of the ply surface area, such as from about 5 to about 50 percent of the ply surface area, more preferably from about 10 to about 50 percent and still more preferably from about 20 to about 50 percent.

As used herein the term “Dot Embossment” generally refers to an embossment having a ratio of embossment length, measured along the longest dimension of the embossment, to embossment width, measured along the shortest dimension of the embossment, of about 1:1. Non-limiting examples of dot embossments are embossments that are shaped like circles, squares, rectangles, or diamonds. A plurality of spaced apart dot embossments that are substantially visually connected may form a linear element despite the embossments being spaced apart from one another.

A used herein the term “Line Embossment” generally refers to an embossment having a ratio of embossment length, measured along the longest dimension of the embossment, to embossment width, measured along the shortest dimension of the embossment, of greater than 1.

As used herein, the term “Embossment Plane” generally refers to the plane formed by the upper surface of the depressed portion of the tissue product forming the embossment. In certain embodiments the tissue product of the present invention may have a single embossing element plane, while in other embodiments the structure may have multiple embossing element planes. The embossing element plane may be determined by imaging a cross-section of the tissue product and drawing a line tangent to the upper most surface of an embossment where the line is generally parallel to the x-axis of the tissue product.

As used herein the terms “Protuberance” and “Embossing Element” generally refer to any protuberance, boss, lug, finger, head, step, surface, or the like, disposed on the surface of a roll and having a z-directional height when measured from the axis of the roll, or some other common reference point. Generally, the height is measured from the “base surface” of the roll, which is understood to be the peripheral surface of the roll having the least radial height when measured from the axis of the roll, or some other common reference point.

As used herein the term “Basis Weight” (BW) generally refers to the bone-dry weight per unit area of a tissue and is generally expressed as grams per square meter (gsm). Basis weight is measured using TAPPI test method T-220. While basis weight may be varied, tissue products prepared according to the present invention generally have a basis weight greater than about 10 gsm, such as from about 10 to about 80 gsm and more preferably from about 30 to about 60 gsm.

As used herein, the term “Caliper” is the representative thickness of a single sheet (caliper of tissue products comprising two or more plies is the thickness of a single sheet of tissue product comprising all plies) measured in accordance with TAPPI test method T402 using a ProGage 500 Thickness Tester (Thwing-Albert Instrument Company, West Berlin, NJ). The micrometer has an anvil diameter of 2.22 inches (56.4 mm) and an anvil pressure of 132 grams per square inch (per 6.45 square centimeters) (2.0 kPa). The caliper of a tissue product may vary depending on a variety of manufacturing processes and the number of plies in the product, however, tissue products prepared according to the present invention generally have a caliper greater than about 600 μm, more preferably greater than about 700 μm and still more preferably greater than about 800 μm, such as from about 600 to about 900 μm.

As used herein the term “Sheet Bulk” refers to the quotient of the caliper (generally having units of μm) divided by the bone-dry basis weight (generally having units of gsm). The resulting sheet bulk is expressed in cubic centimeters per gram (cc/g). While sheet bulk may vary depending on any one of a number of factors, tissue products prepared according to the present invention may have a sheet bulk greater than about 8.0 cc/g, more preferably greater than about 9.0 cc/g, still more preferably greater than about 10.0 cc/g and still more preferably greater than about 11.0 cc/g, such as from about 8.0 to about 14.0 cc/g, such as from about 10.0 to about 12.0 cc/g.

As used herein, the term “Geometric Mean Tensile” (GMT) refers to the square root of the product of the machine direction tensile strength and the cross-machine direction tensile strength of the tissue product. While the GMT may vary, tissue products prepared according to the present invention may have a GMT greater than about 700 g/3″, such as from about 700 to about 1,400 g/3″, such as from about 700 to about 1,200 g/3″, such as from about 700 to about 1,000 g/3″.

As used herein, the term “Stretch” generally refers to the ratio of the slack-corrected elongation of a specimen at the point it generates its peak load divided by the slack-corrected gauge length in any given orientation. Stretch is an output of the MTS TestWorks™ in the course of determining the tensile strength as described in the Test Methods section herein. Stretch is reported as a percentage and may be reported for machine direction stretch (MDS), cross-machine direction stretch (CDS) or as geometric mean stretch (GMS), which is the square root of the product of machine direction stretch and cross-machine direction stretch. While the stretch of tissue products prepared according to the present invention may vary, in certain embodiments tissue products prepared as disclosed herein have a GMS greater than about 8 percent, more preferably greater than about 10 percent and still more preferably greater than about 12 percent, such as from about 8 to about 14 percent, such as from about 10 to about 12 percent.

As used herein, the terms “TS7” and “TS7 value” refer to the output of the EMTEC Tissue Softness Analyzer (commercially available from Emtec Electronic GmbH, Leipzig, Germany) as described in the Test Methods section. TS7 has units of dB V2 rms, however, TS7 may be referred to herein without reference to units. The TS7 value is the frequency peak that occurs around 6.5 kHz on the noise spectrum graph output from the EMTEC Tissue Softness Analyzer. This peak represents the softness of the sample. Generally, softer samples produce a lower TS7 peak.

As used herein, the term “Average TS7” generally refers to the TS7 value for a first and a second side of a tissue product. In certain embodiments the invention provides an embossed multi-ply tissue product, such as a creped, wet-pressed tissue product, having an Average TS7 less than about 12.0 and more preferably less than about 11.0, such as from about 10.0 to about 12.0. The foregoing Average TS7 values may be obtained at a product GMT from about 700 g/3″, such as from about 700 to about 1,400 g/3″, such as from about 700 to about 1,200 g/3″, such as from about 700 to about 1,000 g/3″.

As used herein, the terms “Surface Smoothness,” “TS750” and “TS750 value” refer to the output of the EMTEC Tissue Softness Analyzer (commercially available from Emtec Electronic GmbH, Leipzig, Germany) as described in the Test Methods section. TS750 has units of dB V2 rms, however, TS750 may be referred to herein without reference to units. Generally, TS750 refers to the amplitude of the peak in the frequency range between 200 to 1000 Hz. A high amplitude peak correlates to a rougher surface.

### DETAILED DESCRIPTION

The present inventors have now discovered that multi-ply tissue products having sides with different textures and improved softness and sheet bulk may be produced from embossed tissue plies, particularly embossed, creped, wet-pressed tissue plies, where one of the plies has a plurality of embossments that protrude outwardly from the product surface to provide a more highly textured side. More particularly, the inventors have discovered that tissue products having improved properties may be produced by providing a first ply with embossments that are oriented towards the interior of the product and a second ply with embossments that are oriented away from the interior so as to protrude from the surface. In this manner the tissue product may have a first surface comprising a plurality of inwardly protruding embossments and a surface smoothness, measured as a TS750 value, of about 50 or less, such as from about 10 to about 50, and a second surface comprising a plurality of outwardly protruding embossments and a surface smoothness, measured as a TS750 value, of about 100 or more, such as from about 100 to about 150.

Preferably the individual plies making up the tissue products of the present invention are manufactured by the same tissue manufacturing process and then converted into the inventive multi-ply product by plying the webs together with embossing to impart the first and second surfaces with differing textures. In this manner, the dual texture is imparted by embossing rather than combining plies having different surface properties, such as plies made by two different manufacturing processes. This simplifies the manufacturing process, but still provides for a unique product having different textures on its first and second sides.

Accordingly, in certain embodiments, the present invention provides a multi-ply tissue product consisting essentially of a first creped, wet-pressed tissue ply and a second creped, wet-pressed tissue ply, where the plies have similar basis weights and tensile strengths. During the converting processes the first and second plies are embossed and plied together to form the inventive product. While the first and second plies are substantially similar, they are embossed differently to impart the different textures. Particularly, the first ply is embossed such that the embossments are oriented towards the interior of the product and the second ply is embossed such that the embossments are oriented away from the interior.

In a particularly preferred embodiment not only does the orientation of the embossments differ between the plies—the first embossments being oriented towards the product interior and the second embossments being oriented away from the product interior—but the first and second embossments are preferably arranged to form different patterns. Accordingly, the invention provides a tissue product comprising a first, uppermost, ply having a plurality of first embossments arranged in a first embossing pattern and a second, bottommost, ply comprising a plurality of second embossments arranged in a second embossing pattern, where the first and second embossing patterns are different. In a particularly preferred embodiment, the plurality of second embossments are micro-embossments disposed on the bottommost ply at a density of 25 embossments/cm² or more, such as at least about 30 embossments/cm², such as at least about 40 embossments/cm², such as from 25 to about 80 embossments/cm². Regardless of the density, the micro-embossments are disposed on the bottommost ply in a pattern that differs from the embossing pattern disposed on the uppermost ply.

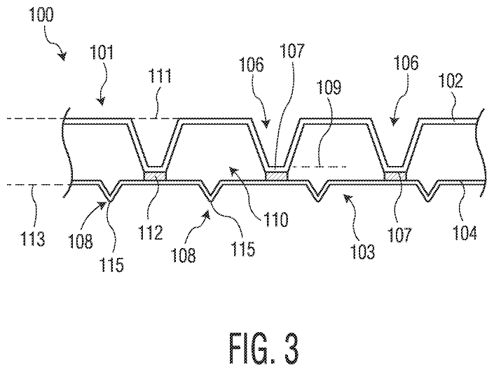

With reference now to FIG. 3, one embodiment of a multi-ply tissue product 100 according to the present invention is illustrated. The tissue product 100 comprises first and second 101, 103 outer surfaces formed by first and second embossed tissue plies 102, 104, respectively. The first and second plies 102, 104 are arranged in facing arrangement with one another and form an interior portion 110 there between. While the product of FIG. 3 is illustrated as consisting of only a first and second ply, the invention is not so limited. For example, the tissue product may comprise additional plies disposed between the first and the second plies, such that the first and second plies face one another, but do not contact one another.

The first embossed tissue ply 102 comprises a plurality of embossments 106 in the form of depressions oriented towards the interior portion 110. In this manner the embossments 106 are in the form of depressions having a distal end 107 lying in an embossment plane 109 below the surface plane 111 of the first ply 102. An adhesive 112 may be used to attach the first and second plies 102, 104. In certain preferred embodiments, such as illustrated in FIG. 3, the adhesive 112 may be disposed at the distal end 107 of the first ply embossments 106 and brought into contact with the second ply 104 to attach the plies 102, 104.

With continued reference to FIG. 3, the second tissue ply 104 also comprises a plurality of embossments 108, however the embossments 108 are not oriented towards the interior portion 110. Instead, the second ply embossments 108 protrude outward from the second ply surface plane 113. In this manner, the embossments 108 have distal ends 115 oriented away from the interior portion 110 and below the bottom ply surface plane 113. As the second ply embossments 108 protrude outwardly from the second ply surface plane 113 they may be contacted by a user in use.

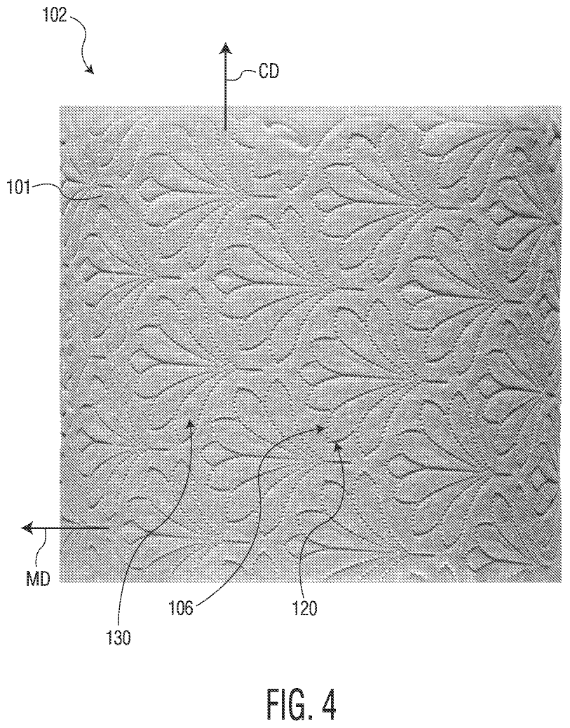

In certain instances, the embossments disposed on the upper and lower plies may differ in at least one regard. For example, the upper-most ply may comprise embossments arranged to form a first pattern and the bottom-most ply may comprise embossments arranged to form a second pattern. One example of an embossing pattern that may be disposed on the upper-most ply, also referred to herein as the first ply, is illustrated in FIG. 4. The first ply 102 comprises a plurality of discrete dot embossments 106 that are arranged to form flower-shaped motifs 120 that are repeated to form a pattern 130. The discrete dot embossments 106 extend below the surface 101. In this manner the first ply embossments are generally formed as depressions lying below the surface plane.

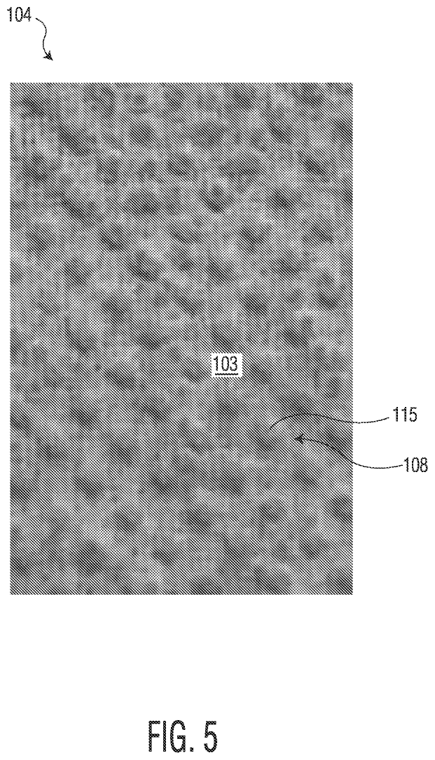

Referring now to FIG. 5, one example of an embossing pattern that may be disposed on the bottom-most ply, also referred to herein as the second ply, is illustrated. The second ply 104 comprises a plurality of discrete dot embossments 108 that have distal ends 115 that lie in a plane above the surface 103. In this manner the second ply embossments 108 are generally formed as protrusions that extend outwardly from the second ply surface 103 having ends 115 that lie above the surface plane.

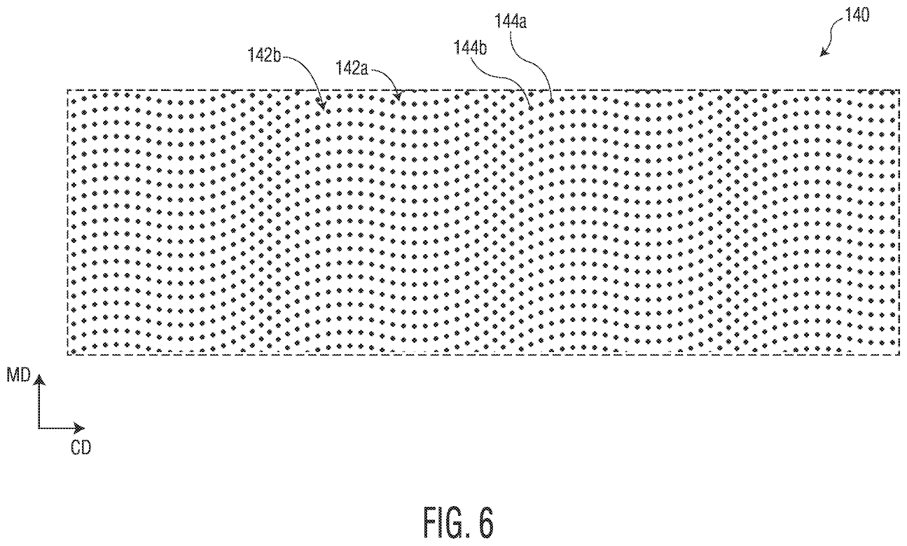

Another example of an embossing pattern 140 that may be incorporated into the second ply of a tissue product in accordance with the present invention is illustrated in FIG. 6. The embossing pattern 140 comprises a plurality of dot emboss elements 144a, 144b that are arranged to form the pattern 140. In the illustrated embodiment, the dot emboss elements 144a, 144b are arranged to form spaced apart, continuous, curvilinear elements 142a, 142b having a wave-like shape. In those embodiments where one or more of the patterns consist of a wave-like shape, such as a sinusoidal wave, the amplitude may range from about 10 to about 40 mm and still more preferably from about 18 to about 22 mm, and the wavelength may range from about 50 to about 200 mm and still more preferably from about 80 to about 120 mm.

Regardless of the specific pattern, it is generally preferred the bottommost ply of a product comprises an embossing pattern that is different than that disposed on the first and arranged such that the embossments protrude outwardly from the bottommost ply surface. Generally, the pattern will be disposed on the entirety of the bottommost ply, extending from a first edge to a second edge of the ply. The may preferably comprise a plurality of dot emboss elements, which themselves may take various shapes such as, for example, circles, ovals, diamonds, hexagons, triangles, or any other suitable geometric formation. In particularly preferred embodiments the dot emboss elements are circular and have a diameter from about 0.075 to about 0.25 cm. In a preferred embodiment the pattern contains a continuous and regular pattern of dot embossments, which are preferably micro-embossments. Examples of suitable dot, micro-embossment shapes include circles, ovoid and squares having an aspect ratio of from 1 to about 1.25, such as from about 1 to about 1.1. These embossments may be homogeneous in size and shape or can vary within a given pattern.

In those embodiments where the second ply comprises a plurality of micro-embossments, the embossments may be disposed in a density of 25 embossments/cm² or greater, more preferably about 40 embossments/cm² or greater. In certain embodiments both the spacing between dot emboss elements within a given linear element and dot embossments in adjacent elements may be substantially uniform for a given pattern. In other embodiments the spacing may be varied amongst intra-element dot emboss elements and inter-element dot emboss elements. Accordingly, in certain instances the dot emboss element density may be substantially uniform throughout a given pattern and in other instances the density may vary within a given pattern to have areas of higher and lower density.

As noted previously, in certain preferred embodiments the improved tissue product properties are achieved by embossing the first and second outer-plies with different embossing patterns, such as embossing patterns having different element shapes, size, scale, or density. The use of two different embossing patterns not only improves the properties of the tissue product but may also be used to impart the product with two unique patterns that provides a distinctive look and is appealing to consumers. For example, in one embodiment the tissue product may have a first ply with a first embossing pattern where the embossing pattern comprises a plurality of embossments and covers from about 2 to about 15 percent, such as from about 5 to about 10 percent, of the first ply surface area. The second ply may be provided with a second embossing pattern, which is different from the first pattern, and covers from 5 percent to about 50 percent of the second ply surface area and more preferably from about 10 to about 50 percent and still more preferably from about 20 to about 50 percent.

In other embodiments the first embossing pattern may comprise a plurality of dot embossments that may be disposed on a first ply to form an embossing pattern covering from about 3 to about 15 percent, even more preferably from about 3 to about 10 percent and still more preferably from about 3 to about 8 percent, to the first ply surface area. The second ply may comprise a plurality of circular shaped micro-embossments and covers from 10 percent to about 50 percent of the second ply surface area.

Providing the first and second outer-most plies with different embossing patterns not only provides an aesthetically pleasing tissue product, but the resulting product may also have certain improved physical properties. For example, the tissue product may have different surface properties for each of the first and the second surfaces, such as different surface textures. The first surface may have a first surface smoothness, expressed as a first TS750 value, and the second surface may have a second surface, expressed as a section TS750 value, where the second TS750 is at least about 50 percent greater than the first TS750 value. In other embodiments second outer-most ply may have a TS750 value that is at least about 100 percent greater, such as at least 200 percent greater, such as at least 300 percent greater, such as at least 400 percent greater, such as at least 500 percent greater, than the TS750 value of the first outer-most ply.

In certain embodiments the first surface may be relatively smooth such that it has a TS750 of about 50 or less, such as from about 10 to about 50, and a second surface may have more texture, such that it has a TS750 value of about 100 or more, such as from about 100 to about 150.

In addition to have differing textures, the first and second sides may also have differing degrees of softness. While it may be advantageous for the sides to differ to a degree with respect to softness, both sides preferably have a handfeel that is soft to the consumer, such as a TS7 value less than about 14.0 and more preferably less than about 12.0. For example, in certain embodiments the product may comprise a first ply forming the first outer surface having a TS7 of about 10.0 or less, such as from about 8.0 to about 10.0, a second ply forming the second outer surface having a TS7 of about 10.0 or greater, such as from about 10.0 to about 14.0.

In still other embodiments the multi-ply tissue products may have an average TS7 from about 9.0 to about 12.0 and more preferably from about 9.0 to about 11.0. The foregoing average TS7 values may be obtained at a product geometric mean tensile strength from about 700 to about 1,100 g/3″ such as from about 800 to about 1,000 g/3″.

In addition to having improved tactile properties the inventive tissue products may also have improved thickness, measured as caliper, and sheet bulk. For example, the products may have a caliper of at least about 275 μm, such as at least about 285 μm, such as at least about 295 μm, such as from about 275 to about 330 μm. The foregoing calipers may be achieved at basis weights ranging from about 28.0 to about 34.0 gsm, providing the products with sheet bulks ranging from about 8.0 to about 12.0 cc/g.

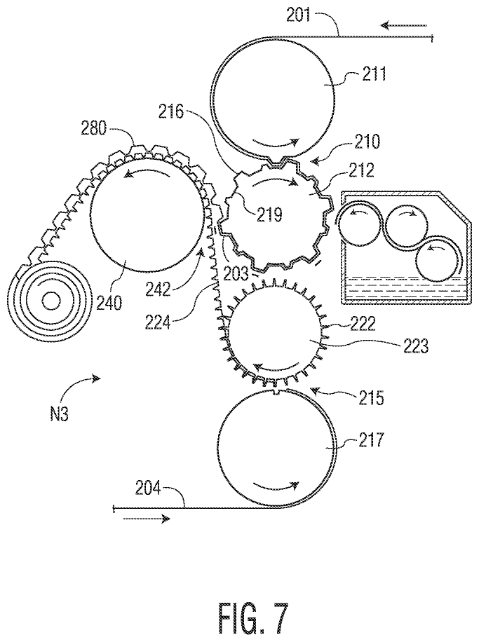

The multi-ply tissue products of the present invention may be manufactured using the apparatus shown in FIG. 7. To produce a first embossed ply, a first tissue ply 201, which will form the uppermost ply of the finished tissue product, is unwound from a first parent roll, and conveyed past a series of idler rollers towards a first embossing nip 210 located between a first engraved embossing roll 212 and a first impression roll 211.

The engraved embossing roll 212 is generally a hard and non-deformable roll, such as a steel roll, and comprises a plurality of protuberances 216, also referred to herein as embossing elements, extending radially from a first peripheral surface 219. The protuberances are arranged so as to form at least a first embossing pattern. The protuberances have a radial height generally measured from the first peripheral surface of the roll, which is understood to be the circumferential surface of the roll having the least radial height when measured from the axis of the roll, or some other common reference point. In certain embodiments the radial height of the protuberances may be about 1.30 mm or greater, such as from about 1.30 to about 1.50 mm and more preferably from about 1.35 to about 1.45 mm.

The protuberances of the first engraved roll may comprise a first pattern consisting of linear elements, and more preferably continuous line elements, where the linear elements are spaced apart from one another to form land areas there between. The land areas may be continuous or discontinuous within a given dimension of the engraved roll depending on the arrangement of linear elements forming the first pattern. The pattern may be continuous along at least one dimension of the engraved roll and even more preferably is a regular, repeating pattern disposed across at least one dimension of the engraved roll.

The spacing and arrangement of the elements forming the first pattern may vary depending on the desired tissue product properties and appearance. The shape of the element may also be varied to provide the desired tissue product properties and appearance. For example, in one embodiment, the linear elements forming the first pattern are curvilinear and more preferably sinusoidal and are arranged substantially parallel to one another such that none of the elements intersect one another. In other embodiments the linear elements may occur as wave-like patterns that are arranged in-phase with one another such that the spacing between adjacent elements is substantially constant. In other embodiments the linear elements may form a wave pattern where adjacent elements are offset from one another.

Regardless of the particular first element shape and the resulting motif and pattern, or whether adjacent elements within a pattern are in or out of phase with one another, it is generally preferred that there is some portion of the roll surface along which adjacent elements within a pattern are separated from one another. In this manner the roll comprises land areas between adjacent elements. In a particularly preferred embodiment, the first pattern comprises a plurality of spaced apart linear elements where the pattern is disposed continuously across both the x and y dimensions of the engraved roll surface and adjacent linear elements are spaced apart from one another in the y-dimension at least about 1.0 cm, such as from about 1.0 to about 5.0 cm and more preferably from about 2.0 to about 4.0 cm.

With reference again to FIG. 7, the first engraved embossing roll 212 is urged against the first impression roll 211, which preferably has a substantially smooth deformable outer surface. In certain instances, the impression roll 211 may be a roll with a covering made of natural or synthetic rubber, for example, polybutadiene or copolymers of ethylene and propylene, or the like. In a particularly preferred embodiment, the outer surface of the impression roll 211 has a hardness greater than about 40 Shore A), such as from about 40 to about 100 Shore (A) and more preferably from about 40 to about 80 Shore (A). By providing an impression roll with the foregoing hardness levels, the designs of the engraved embossing roll 212 are not pressed into the impression roll 211 as deep as in conventional apparatuses.

The first impression roll 211 and the first engraved embossing roll 212 are urged together to form a first embossing nip 210 through which the first tissue ply 201 passes to impose a first embossing pattern thereon. Generally, a force or pressure is applied to one or both of the rolls such that the rolls are urged against one another causing the impression roll to deform about the protuberances such that when the ply is pressed about the protuberances and onto the landing areas (i.e., the outer surface areas of the roll surrounding the protuberances) an embossment results. As the embossed first tissue ply exits the first embossing nip 210 it comprises a plurality of embossments having distal ends.

To form a two-ply tissue product, a second parent roll is unwound and the second tissue ply 204 is conveyed around an idler roller and is then passed into a second embossing nip 215 formed between a second impression roll 217 and a second engraved embossing roll 223. The second impression roll 217 generally has a smooth outer surface, which may be deformable. In certain instances, the second impression roll 217 has an outer covering comprising a natural or synthetic rubber and may have a hardness greater than about 40 Shore (A), such as from about 40 to about 100 Shore (A). The second engraved embossing roll 223 generally comprises a plurality of protuberances 222 extending from its peripheral surface. The protuberances are generally in the form of dot elements and form a second embossing pattern. In certain embodiments the protuberances disposed on the second engraved embossing roll 223 may have a height of at least about 0.4 mm, such as from about 0.4 to about 2.0 mm.

As the second ply 204 passes through the second embossing nip 215 it is imparted with a plurality of dot emboss elements, which may be arranged to form a pattern. The embossed second ply 224 is then conveyed and brought into facing relation with the embossed first ply 203 using a marrying roll 240. While in certain instances the second engraved embossing roll 223 and impression roll 217 may be arranged relatively close to the first pair of rolls 211, 212 and the marrying roll 240, this is not necessary as the present method does not rely upon registration of the first and second embossing patterns with one another. In this manner, the present method differs from so called nested-method embossing, such as that described in U.S. Publication No. 2012/0156447, where the embossing elements of the first embossing roll and the embossing elements of the second embossing roll are arranged such that the embossed elements of the first embossed ply and the embossed elements of the second embossed ply fit into each other similar to a gearing system.

In a particularly preferred embodiment, the second ply 204 is provided with a plurality of micro-embossments as it passed through the second embossing nip 215 as a result of the second embossing roll 223 having embossing elements ranging from about 0.5 to about 1.5 mm, such as from about 0.8 to about 1.2 mm in height. As used herein, “height” refers to the measurement of the shortest dimension of the micro-embossment element. The angle of the sidewalls of the micro-embossment elements may range from about 0 to about 25 degrees, such as from about 0 to about 15 degrees.

After the embossed second ply 224 leaves the second embossing nip 215 it is brought into facing relationship with the embossed first ply 203. The two embossed plies 203, 224 are conveyed through a third nip 242 formed between the first engraved embossing roll 212 and a marrying roll 240, which may be a steel roll having a substantially smooth outer surface. The first and second embossed plies 203, 224 are joined together as they pass through the third nip 242 to form a multi-ply tissue product 280.

In certain embodiments, after exiting the first embossing nip 210 the first embossed ply 203 encounters a gluing unit 250, which comprises an adhesive 251 disposed in a reservoir and an applicator roll 252. Adhesive 251 is transferred to the applicator roll 252 and applied to the distal ends 232 of the embossments 230 that are formed on the exterior surface of the embossed first tissue ply 203 by virtue of contact with the first protuberances 216. The embossed first tissue ply 203 with the applied adhesive 251 then advances further to the third nip 242 between the first engraved embossing roll 212 and the marrying roll 240. At this point, the embossed second ply 224 is attached to the embossed first ply 203 and then conveyed through the third nip 242 to form an adhesively laminated two-ply tissue product 280 which is subsequently wound into a roll (not shown).

The resulting two-ply tissue product comprises embossed first and second plies with the first embossed ply forming the upper most surface of the tissue product and the second ply forming the bottom most surface. In certain embodiments the first embossed ply may comprise a first embossed pattern consisting essentially of a plurality of dot embossments forming curvilinear line element embossments and the second ply may comprise a plurality of dot emboss elements disposed thereon.

In certain embodiments, to improve processability and one or more physical properties, one or more of the fibrous plies may be subjected to preconditioning to impart moisture and/or heat to the tissue plies prior to entering an embossing nip. For example, preconditioning mechanisms may be positioned upstream of the nip located between the engraved roll and the impression role to introduce moisture and/or heat to the first tissue ply prior to embossing. Methods and arrangements for applying moisture and heat (e.g., steam) to tissue webs are known to skilled artisans and can be employed and fall within the scope of the present invention. By way of example, steam can be applied to either or both sides of a web prior to embossing.

Tissue webs useful in forming the multi-ply tissue products of the present invention may be formed using any one of several well-known manufacturing processes. Particularly preferred are creped, wet-pressed processes, particularly Valmet's New Tissue Technology (NTT), Advantage Quality Rush Transfer (“QRT”) processes and Energy Efficient Technologically Advanced Drying (ETAD), and Voith's Advanced Tissue Molding System (ATMOS) process.

Multi-ply tissue products produced according to the present invention not only have first and second patterns that may be aesthetically pleasing to a consumer, but they may also have favorable physical properties, such as sufficient strength to withstand use while also being soft and having good handfeel. Accordingly, in one embodiment the present invention provides an embossed multi-ply tissue product comprising: a first tissue ply having a first side and an opposite second side, the first side having a first embossed pattern and a first surface smoothness; a second tissue ply having a first side and an opposite second side, the first side having a second embossed pattern and a second surface smoothness, where the first and second emboss patterns are different and the first surface smoothness is less than the second surface smoothness. The foregoing tissue products preferably have a basis weight from about 10 to about 100 gsm, such as from about 15 to about 60 gsm, such as from about 25 to about 40 gsm and a sheet bulk greater than about 8.0 cc/g, more preferably greater than about 9.0 cc/g, still more preferably greater than about 10.0 cc/g and still more preferably greater than about 11.0 cc/g, such as from about 8.0 to about 14.0 cc/g, such as from about 10.0 to about 12.0 cc/g.

In addition to having the foregoing basis weights and sheet bulks, multi-ply tissue products prepared according to the present invention may have a geometric mean tensile (GMT) greater than about 700 g/3″, such as from about 700 to about 1,400 g/3″, such as from about 700 to about 1,200 g/3″, such as from about 700 to about 1,000 g/3″. At these tensile strengths the tissue webs and products have relatively low Average TS7 values, such as less than about 12.0 and more preferably less than about 11.0, such as from about 10.0 to about 12.0.

Inventive products were manufactured by first preparing a basesheet having a target basis weight of about 15 gsm using a conventional creped, wet-pressed process such as that illustrated in FIG. 4 of U.S. Pat. No. 8,262,857, the contents of which are incorporated herein a manner consistent with the present invention. The basesheet was then converted by calendering, embossing, plying, and winding to yield an embossed two-ply tissue product according to the present invention.

Basesheet was converted into two-ply rolled tissue products, substantially as illustrated in FIG. 7, by embossing the first and second plies separately and laminating the embossed plies to form a two-ply tissue product. The first ply was embossed using an embossing roll engraved to provide the ply with an embossed pattern substantially similar to that illustrated in FIG. 4. The second ply was embossed using an embossing roll engraved to provide the ply with an embossed pattern substantially similar to that illustrated in FIG. 5, which comprised approximately 60 dot emboss elements per square centimeter. In certain instances, finished product tensile strength was varied by refining the furnish prior to manufacture of the basesheet. In other instances, the pressure of the second embossing nip was varied to provide a varying degree of texture to the bottom ply. The two-ply tissue product was subjected to physical testing, the results of which are shown in Tables 1 and 2, below.

TABLE 1

| | Second | Basis | | Sheet | | MD |
|---|---|---|---|---|---|---|
| | Embossing | Weight | Caliper | Bulk | GMT | Stretch |
| Sample | Nip Pressure | (gsm) | (μm) | (cc/g) | (g/3″) | (%) |
| 1 | Low | 30.9 | 289 | 9.4 | 915 | 17.6 |
| 2 | Low | 30.0 | 302 | 10.1 | 746 | 19.2 |
| 3 | High | 29.1 | 329 | 11.3 | 665 | 17.0 |

TABLE 2

| | |
|---|---|
| Upper (First) Ply | Lower (Second) Ply |

| Sample | TS7 | TS750 | D | TS7 | TS750 | D |
|---|---|---|---|---|---|---|
| 1 | 10.5 | 16.4 | 3.1 | 11.8 | 82.3 | 3.0 |
| 2 | 9.8 | 17.0 | 3.2 | 12.9 | 97.8 | 3.1 |
| 3 | 8.3 | 16.9 | 3.3 | 13.5 | 96.0 | 3.2 |

Embossing the plies with different patterns, such that embossments protruded outwardly from the surface of the second ply, had the effect of providing each ply with different surface smoothness and softness properties. Embossing the plies according to the present invention also had the effect of increasing the caliper, and in-turn the sheet bulk, of the finished product. Generally, embossing the products according to the present invention increased sheet bulk from about 10 to about 20 percent compared to conventionally embossed products. Embossing the products in this manner also resulted in each ply having a distinctive texture such that the surface smoothness of the second ply was about 5 times greater than that of the first ply, as summarized in Table 3, below.

TABLE 3

| Sample | Average TS7 | Bottom:Top TS750 Ratio |
|---|---|---|
| 1 | 11.1 | 5.0:1 |
| 2 | 11.4 | 5.0:1 |
| 3 | 10.9 | 5.8:1 |

### Test Methods

### Sheet Bulk

Sheet Bulk is calculated as the quotient of the dry sheet caliper (μm) divided by the bone dry basis weight (gsm). Dry sheet caliper is the measurement of the thickness of a single sheet of tissue product (comprising all plies) measured in accordance with TAPPI test method T402 using a ProGage 500 Thickness Tester (Thwing-Albert Instrument Company, West Berlin, NJ). The micrometer has an anvil diameter of 2.22 inches (56.4 mm) and an anvil pressure of 132 grams per square inch (per 6.45 square centimeters) (2.0 kPa).

### Tensile

Tensile testing was done in accordance with TAPPI test method T-576 “Tensile properties of towel and tissue products (using constant rate of elongation)” wherein the testing is conducted on a tensile testing machine maintaining a constant rate of elongation and the width of each specimen tested is 3 inches. More specifically, samples for dry tensile strength testing were prepared by cutting a 3±0.05 inch (76.2±1.3 mm) wide strip in either the machine direction (MD) or cross-machine direction (CD) orientation using a JDC Precision Sample Cutter (Thwing-Albert Instrument Company, Philadelphia, PA, Model No. JDC 3-10, Serial No. 37333) or equivalent. The instrument used for measuring tensile strengths was an MTS Systems Sintech 11S, Serial No. 6233. The data acquisition software was an MTS TestWorks® for Windows Ver. 3.10 (MTS Systems Corp., Research Triangle Park, NC). The load cell was selected from either a 50 Newton or 100 Newton maximum, depending on the strength of the sample being tested, such that the majority of peak load values fall between 10 to 90 percent of the load cell's full scale value. The gauge length between jaws was 4±0.04 inches (101.6±1 mm) for facial tissue and towels and 2±0.02 inches (50.8±0.5 mm) for bath tissue. The crosshead speed was 10±0.4 inches/min (254±1 mm/min), and the break sensitivity was set at 65 percent. The sample was placed in the jaws of the instrument, centered both vertically and horizontally. The test was then started and ended when the specimen broke. The peak load was recorded as either the “MD tensile strength” or the “CD tensile strength” of the specimen depending on the direction of the sample being tested. The geometric mean tensile (GMT) strength was calculated and is expressed as grams-force per 3 inches of sample width. Tensile energy absorbed (TEA) and slope are also calculated by the tensile tester. TEA is reported in units of gm·cm/cm². Slope is recorded in units of kg. Both TEA and Slope are directionally dependent and thus MD and CD directions are measured independently. Geometric mean TEA and geometric mean slope are defined as the square root of the product of the representative MD and CD values for the given property.

The product tensile strength, and related tensile properties, were tested as multi-ply products and results represent the tensile strength of the total product. For example, a two-ply product was tested as a two-ply product and recorded as such. Five representative specimens were tested for each multi-ply product and the arithmetic average of all individual specimen tests was recorded as the appropriate tensile property of the sample.

The tensile strength, and related tensile properties, of individual plies of a multi-ply product were tested as individual single plies. Prior to testing each individual ply, care was taken to separate each ply of a multi-ply product to ensure that the ply was undamaged. Plies having any tears or defects were discarded. Five representative specimens were tested for each multi-ply product, with each ply being tested individually, and the arithmetic average of all individual specimen tests was recorded as the appropriate tensile property of the given ply.

### Tissue Softness

Tissue softness was measured using an EMTEC Tissue Softness Analyzer (“TSA”) (Emtec Electronic GmbH, Leipzig, Germany). The TSA comprises a rotor with vertical blades which rotate on the test piece applying a defined contact pressure. Contact between the vertical blades and the test piece creates vibrations, which are sensed by a vibration sensor. The sensor then transmits a signal to a PC for processing and display. The signal is displayed as a frequency spectrum. For measurement of TS7 values the blades are pressed against the sample with a load of 100 mN and the rotational speed of the blades is two revolutions per second.

The frequency analysis in the range of approximately 200 to 1000 Hz represents the surface smoothness or texture of the test piece. The peak in the frequency range between 200 to 1000 Hz is herein referred to as the TS750 value and is expressed as dB V² rms. A high amplitude peak correlates to a rougher surface.

A further peak in the frequency range between 6 and 7 kHz represents the softness of the test piece. The peak in the frequency range between 6 and 7 kHz is herein referred to as the TS7 value and is expressed as dB V² rms. The lower the amplitude of the peak occurring between 6 and 7 kHz, the softer the test piece.

In addition to TS750 and TS7, the analyzer reports a stiffness parameter (D) having units of mm/N. The stiffness parameter (D) is the deformation of the sample under a defined load.

Test samples were prepared by cutting a circular sample having a diameter of 112.8 mm. All samples were allowed to equilibrate at TAPPI standard temperature and humidity conditions for at least 24 hours prior to completing the TSA testing. The sample is secured to the testing apparatus according to the manufacturer's instructions, and the measurements are started via the PC. The PC records, processes, and stores all of the data according to standard TSA protocol. The reported values are the average of five replicates, each one with a new sample.

### Embodiments

First embodiment: An embossed multi-ply tissue product comprising a first embossed tissue ply and a second embossed tissue ply arranged in facing relation and defining an interior portion there between, a plurality of first embossments disposed on the first ply and arranged in a first pattern, the plurality of first embossments oriented towards the interior portion of the product and a plurality of second embossments disposed on the second ply and arranged in a second pattern, the second embossments oriented away from the interior portion of the product, wherein the first and second patterns differ and the second ply has a TS750 value that is at least about five times greater than the TS750 value of the first ply.

Second embodiment: The product of the first embodiment wherein the first and second plies are creped, wet-pressed tissue plies.

Third embodiment: The product of the first or second embodiments wherein the embossed area of the first ply ranges from about 3 to about 15 percent, even more preferably from about 3 to about 10 percent and still more preferably from about 3 to about 8 percent, and the embossed area of the second ply ranges from 5 percent to about 50 percent of the second ply surface area and more preferably from about 10 percent to about 50 percent and still more preferably from about 20 percent to about 50 percent.

Fourth embodiment: The product of any one of the first through third embodiments wherein the first emboss pattern is substantially free form micro-embossments and the second emboss pattern consists essentially of micro-embossments.

Fifth embodiment: The product of any one of the first through fourth embodiments wherein the embossments disposed on the second ply are micro-embossments and cover from about 10 to about 30 percent of the second ply surface area.

Sixth embodiment: The product of any one of the first through fifth embodiments having a basis weight from about 20 to about 60 grams per square meter (gsm) and a sheet bulk of about 10.0 cubic centimeters per gram (cc/g) or greater.

Seventh embodiment: The product of any one of the first through sixth embodiments having an Average TS7 value from about 10.0 to about 12.0.

Eighth embodiment: The product of any one of the first through seventh embodiments wherein the TS750 value of a first outer product surface formed by the first ply ranges from about 10 to about 50, and the TS750 value of a second outer product surface formed by the second ply ranges from about 100 to about 150.

What is claimed is:

1. An embossed multi-ply tissue product comprising a first embossed tissue ply and a second embossed tissue ply arranged in facing relation and defining an interior portion there between, a plurality of first embossments disposed on the first ply and arranged in a first pattern, the plurality of first embossments oriented towards the interior portion of the product and a plurality of second embossments disposed on the second ply and arranged in a second pattern, the second embossments oriented away from the interior portion of the product, wherein the first and second patterns differ and the second ply has a TS750 value that is at least about five times greater than the TS750 value of the first ply.

2. The embossed multi-ply tissue product of claim 1 wherein the first and second plies are creped, wet-pressed tissue plies.

3. The embossed multi-ply tissue product of claim 1 having a basis weight from about 20 to about 60 grams per square meter (gsm) and a sheet bulk of about 10.0 cubic centimeters per gram (cc/g) or greater.

4. The embossed multi-ply tissue product of claim 1 having a caliper from about 275 to about 330 μm.

5. The embossed multi-ply tissue product of claim 1 having a geometric mean tensile strength (GMT) from about 700 to about 1,200 g/3″.

6. The embossed multi-ply tissue product of claim 1 having an Average TS7 value from about 10.0 to about 12.0.

7. The embossed multi-ply tissue product of claim 6 wherein the TS7 value of a first outer product surface formed by the first ply is less than the TS7 value a second outer product surface formed by the second ply.

8. The embossed multi-ply tissue product of claim 1 wherein the TS750 value of a first outer product surface formed by the first ply ranges from about 10 to about 50, and the TS750 value of a second outer product surface formed by the second ply ranges from about 100 to about 150.

9. The embossed multi-ply tissue product of claim 1 wherein the first embossments cover from about 6 to about 15 percent of the first ply surface area and second embossments cover from about 20 to about 50 percent of the second ply surface area.

10. The embossed multi-ply tissue product of claim 1 wherein first pattern comprises 20 embossments per square centimeter or less and the second pattern comprises 25 embossments per square centimeter or more.

11. The embossed multi-ply tissue product of claim 1 wherein the plurality of second embossments have a density of 25 to about 80 embossments per square centimeter and cover from about 20 to about 50 percent of the second ply surface area.

12. The embossed multi-ply tissue product of claim 1 wherein the plurality of second embossments have substantially identical shapes and the shape is selected from the group consisting of circles, squares, rectangles, and diamonds.

13. The embossed multi-ply tissue product of claim 1 wherein the first and second tissue plies are adhesively bonded to one another at a plurality of bonded regions.

14. An embossed multi-ply tissue product having a first and a second outer surface and an interior portion therebetween, the product comprising:
a. a first embossed tissue ply having a plurality of first embossments extending towards the interior portion, the first embossments disposed in a first pattern and at a first density; and
b. a second embossed tissue ply having a plurality of second embossments extending away from the interior portion, the second embossments disposed in a second pattern and at a second density,
wherein the first and second patterns are different;
wherein the first and second densities are different; and
wherein the second embossed tissue ply has a TS750 value that is at least about five times greater than the TS750 value of the first ply.

15. The embossed multi-ply tissue product of claim 14 wherein the first and second plies are creped, wet-pressed tissue plies.

16. The embossed multi-ply tissue product of claim 14 having a basis weight from about 20 to about 60 grams per square meter (gsm) and a sheet bulk of about 10.0 cubic centimeters per gram (cc/g) or greater.

17. The embossed multi-ply tissue product of claim 14 having a geometric mean tensile strength (GMT) from about 700 to about 1,200 g/3″ and an Average TS7 value from about 10.0 to about 12.0.

18. The embossed multi-ply tissue product of claim 14 wherein the first embossments consist essentially of line emboss elements and the second embossments consist essentially of dot emboss elements.

19. The embossed multi-ply tissue product of claim 14 wherein the TS750 value of a first outer product surface formed by the first ply ranges from about 10 to about 50, and the TS750 value of a second outer product surface formed by the second ply ranges from about 100 to about 150.

20. The embossed multi-ply tissue product of claim 14 wherein the first density is 20 embossments per square centimeter or less and the second density is 25 embossments per square centimeter or more.
